(19) United States
(12) Patent Application Publication
(10) Pub. No.: US 2026/0058377 A1
(43) Pub. Date: Feb. 26, 2026

(54) DIRECTIONAL ANTENNA ARRAY

(71) Applicant: Cisco Technology, Inc., San Jose, CA (US)

(72) Inventors: Navid POURRAMZANGANDJI, Copley, OH (US); Fred J. ANDERSON, Lakeville, OH (US); Sivadeep R. KALAVAKURU, Pleasanton, CA (US)

(21) Appl. No.: 18/815,185

(22) Filed: Aug. 26, 2024

(51) Int. Cl. H01Q 21/29; H01Q 21/10; H04W 88/08

(52) U.S. Cl. CPC H01Q 21/293; H01Q 21/10; H04W 88/08

(57) ABSTRACT

The present disclosure describes a directional antenna array. The antenna array includes a first antenna element and a second antenna element. The first antenna element includes a first substrate, a second substrate extending through the first substrate, a first feed coupled to the first substrate, a first radiator coupled to the first substrate and electrically coupled to the first feed, a second feed coupled to the second substrate, and a second radiator coupled to the second substrate and electrically coupled to the second feed. The first feed includes a first portion and a second portion capacitively coupled to the first portion through the second substrate. The second feed includes a third portion and a fourth portion capacitively coupled to the third portion through the first substrate.

### TECHNICAL FIELD

Embodiments presented in this disclosure generally relate to wireless communication. More specifically, embodiments disclosed herein relate to a directional antenna array.

### BACKGROUND

Access points in high density deployments (e.g., auditoriums, warehouses, stadiums, etc.) use antenna arrays to support communication across many devices and users. For example, these access points may use antenna arrays that provide a wide beam, high gain, and high directionality with minimal or reduced sidelobes, which allows for spatial reuse. These access points, however, include a large number of antennas with complex designs and large size, which causes the access points to be large. Additionally, these access points may provide poor radio performance due to large power dissipation.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example access point in the system of FIG. 1.

FIGS. 3A and 3B illustrate example access points in the system of FIG. 1.

FIGS. 4A and 4B illustrate example components of an access point in the system of FIG. 1.

FIG. 5 is a flowchart of an example method performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a directional antenna array. According to an embodiment, an antenna array includes a first antenna element and a second antenna element. The first antenna element includes a first substrate, a second substrate extending through the first substrate, a first feed coupled to the first substrate, a first radiator coupled to the first substrate and electrically coupled to the first feed, a second feed coupled to the second substrate, and a second radiator coupled to the second substrate and electrically coupled to the second feed. The first feed includes a first portion and a second portion capacitively coupled to the first portion through the second substrate. The second feed includes a third portion and a fourth portion capacitively coupled to the third portion through the first substrate.

According to another embodiment, a method includes communicating a message using a first antenna element that includes a first substrate, a second substrate extending through the first substrate and orthogonal to the first substrate, a first feed coupled to the first substrate, a first radiator coupled to the first substrate and electrically coupled to the first feed, a second feed coupled to the second substrate, and a second radiator coupled to the second substrate and electrically coupled to the second feed. The first feed includes a first portion and a second portion capacitively coupled to the first portion through the second substrate. The second feed includes a third portion and a fourth portion capacitively coupled to the third portion through the first substrate. The method also includes communicating a message using a second antenna element.

According to another embodiment, an access point includes a first substrate, a second substrate extending through the first substrate and orthogonal to the first substrate, a first feed coupled to the first substrate, and a second feed coupled to the second substrate. The first feed includes a first portion and a second portion capacitively coupled to the first portion through the second substrate. The second feed includes a third portion and a fourth portion capacitively coupled to the third portion through the first substrate.

### EXAMPLE EMBODIMENTS

The present disclosure describes an access point with an antenna array with cross polarized structures. Generally, the antenna array includes antenna elements with substrates (e.g., printed circuit boards) that are arranged orthogonally to each other and intersect each other. A feed, radiator, reflector, and/or scatterer may be positioned on each substrate. The feed includes separate portions that are positioned on either side of the intersecting substrate and are capacitively coupled to each other. The feeds electrically couple to the radiators to transmit and/or receive wireless signals.

In certain embodiments, the access point provides several technical advantages. For example, the access point provides a high gain (e.g., 7.5 decibel relative to isotrope (dBi)) with a wide beam pattern (e.g., 120×30 degree), and isolation (e.g., greater than 35 decibel (dB)), which may allow for multi-radio coexistence. As another example, the access point has a smaller footprint relative to existing access points (e.g., 9.5×9.5 inches or 14×9.5 inches vs. 24×18 inches).

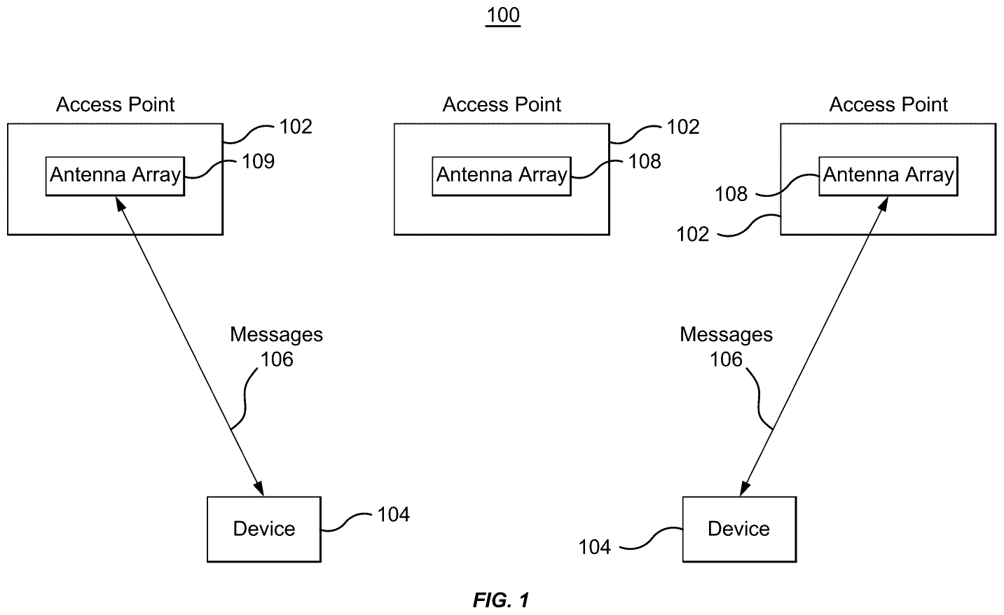

FIG. 1 illustrates an example system 100. Generally, the system 100 may be a high density network deployment (e.g., a network at an auditorium, warehouse, stadium, etc.). As seen in FIG. 1, the system 100 includes one or more access points 102 and one or more devices 104.

The access point 102 facilitates wireless communication (e.g., wireless fidelity (Wi-Fi) communication) in the system 100. One or more devices 104 may connect to the access point 102 using a Wi-Fi protocol or process. The access point 102 may then facilitate wireless communication for the connected devices 104. For example, the access point 102 may transmit messages 106 to a connected device 104. As another example, the access point 102 may receive messages 106 transmitted by the device 104. The access point 102 may then direct those messages towards their intended destinations.

The access point 102 includes an antenna array 108 that the access point 102 uses to transmit and receive messages 106 from the devices 104. The antenna array 108 includes multiple antennas. Each antenna includes multiple antenna elements. Each antenna element is a cross-polarized element formed using intersecting substrates (e.g., printed circuit boards). The substrates may be orthogonal to each other, and a feed with portions that capacitively couple to each other across the intersecting substrate. Radiators and/or reflectors/scatterers may be positioned on the substrates to transmit or receive wireless signals. In certain embodiments, using this structure for the antenna elements provides a wide beam pattern with reduced sidelobes. Additionally, the antenna elements have a smaller footprint relative to existing high density network deployments.

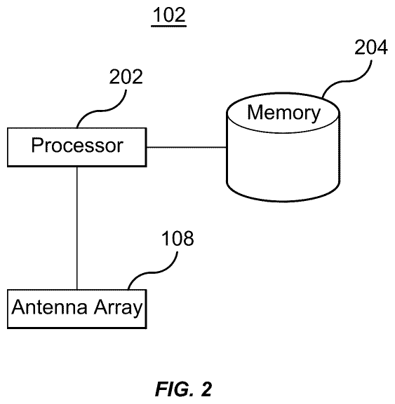

FIG. 2 illustrates an example access point 102 in the system 100 of FIG. 1. As seen in FIG. 2, the access point 102 includes a processor 202, a memory 204, and the antenna array 108. Generally, the processor 202, the memory 204, and the antenna array 108 perform the functions or features of the access point 102 described herein.

The processor 202 is any electronic circuitry, including, but not limited to one or a combination of microprocessors, microcontrollers, application specific integrated circuits (ASIC), application specific instruction set processor (ASIP), and/or state machines, that communicatively couples to the memory 204 and controls the operation of the access point 102. The processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 202 may include other hardware that operates software to control and process information. The processor 202 executes software stored on the memory 204 to perform any of the functions described herein. The processor 202 controls the operation and administration of the access point 102 by processing information (e.g., information received from the memory 204 and antenna array 108). The processor 202 is not limited to a single processing device and may encompass multiple processing devices contained in the same device or computer or distributed across multiple devices or computers. The processor 202 is considered to perform a set of functions or actions if the multiple processing devices collectively perform the set of functions or actions, even if different processing devices perform different functions or actions in the set.

The memory 204 may store, either permanently or temporarily, data, operational software, or other information for the processor 202. The memory 204 may include any one or a combination of volatile or non-volatile local or remote devices suitable for storing information. For example, the memory 204 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 204, a disk, a CD, or a flash drive. In particular embodiments, the software may include an application executable by the processor 202 to perform one or more of the functions described herein. The memory 204 is not limited to a single memory and may encompass multiple memories contained in the same device or computer or distributed across multiple devices or computers. The memory 204 is considered to store a set of data, operational software, or information if the multiple memories collectively store the set of data, operational software, or information, even if different memories store different portions of the data, operational software, or information in the set.

The antenna array 108 may communicate messages or information using different communication technologies. For example, the access point 102 may use the antenna array 108 for Wi-Fi communications or cellular communications. The access point 102 may use the antenna array 108 to transmit messages and to receive messages. The access point 102 may include any number of antenna arrays 108 to communicate using any number of communication technologies (e.g., Bluetooth, UWB, etc.).

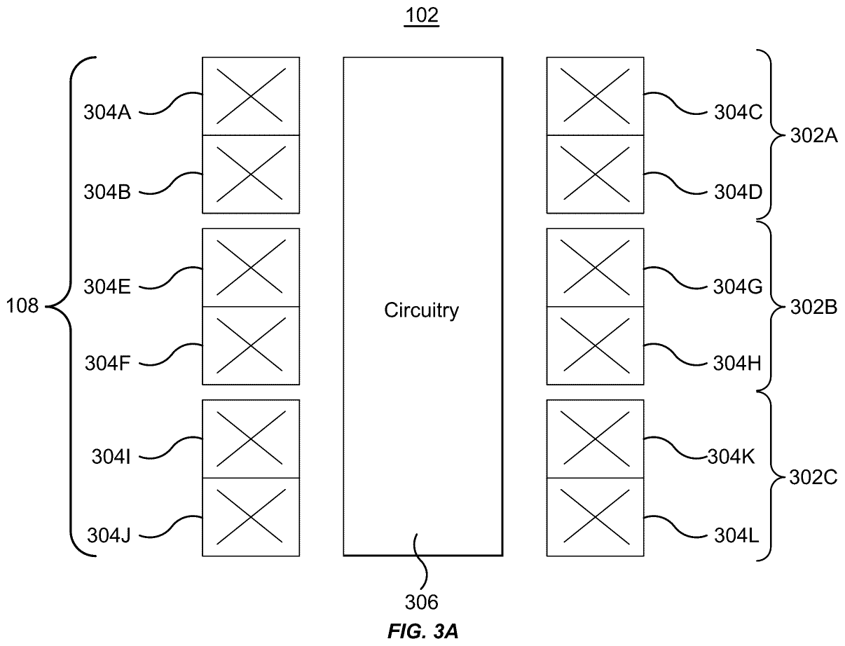

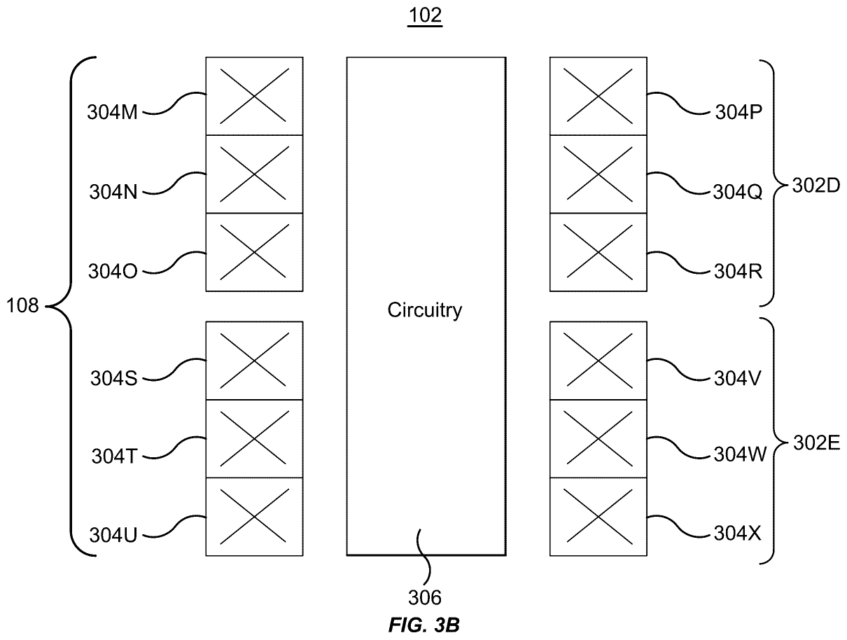

FIGS. 3A and 3B illustrate example access points 102 in the system 100 of FIG. 1. Generally, the access points 102 include antenna arrays with multiple, cross-polarized antenna elements. As seen in FIG. 3A, the access point 102 includes the antenna array 108 with multiple radios 302. Each radio 302 is formed using multiple antenna elements 304. In the example of FIG. 3A, each radio 302 is formed using four antenna elements 304 divided evenly on opposite sides of circuitry 306. The radios 302 may service various bands. For example, the radios 302 may include 5 gigaHertz (GHz) radios and 6 GHz radios.

Specifically, the access point 102 includes the radios 302A, 302B, and 302C. The radio 302A is formed using the antenna elements 304A, 304B, 304C, and 304D. The radio 302B is formed using the antenna elements 304E, 304F, 304G, and 304H. The radio 302C is formed using the antenna elements 304I, 304J, 304K, and 304L. The antenna elements 304A and 304B are positioned on opposite sides of the circuitry 306 from the antenna elements 304C and 304D. The antenna elements 304E and 304F are positioned on opposite sides of the circuitry 306 from the antenna elements 304G and 304H. The antenna elements 304I and 304J are positioned on opposite sides of the circuitry 306 from the antenna elements 304K and 304L.

The circuitry 306 may include other components of the access point 102. For example, the circuitry 306 may include a processor and a memory. As another example, the circuitry may include other radios, such as 2 GHz radios and Internet of Things (IoT) radios. The antenna elements 304 may electrically couple to the circuitry 306. The circuitry 306 may communicate electrical signals to the antenna elements 304, and the antenna elements 304 may transmit wireless signals based on these electrical signals. The antenna elements 304 may receive wireless signals and communicate electrical signals to the circuitry 306 based on these wireless signals.

As seen in FIG. 3B, the access point 102 includes the antenna array 108 with multiple radios 302. Each radio 302 is formed using multiple antenna elements 304. In the example of FIG. 3B, each radio 302 is formed using six antenna elements 304 divided evenly on opposite sides of the circuitry 306. The radios 302 may service various bands. For example, the radios 302 may include 5 GHz radios and 6 GHz radios.

Specifically, the access point 102 includes the radios 302D and 302E. The radio 302D is formed using the antenna elements 304M, 304N, 304O, 304P, 304Q, and 304R. The radio 302E is formed using the antenna elements 304S, 304T, 304U, 304V, 304W, and 304X. The antenna elements 304M, 304N, and 304O are positioned on opposite sides of the circuitry 306 from the antenna elements 304P, 304Q, and 304R. The antenna elements 304S, 304T, and 304U are positioned on opposite sides of the circuitry 306 from the antenna elements 304V, 304W, and 304X.

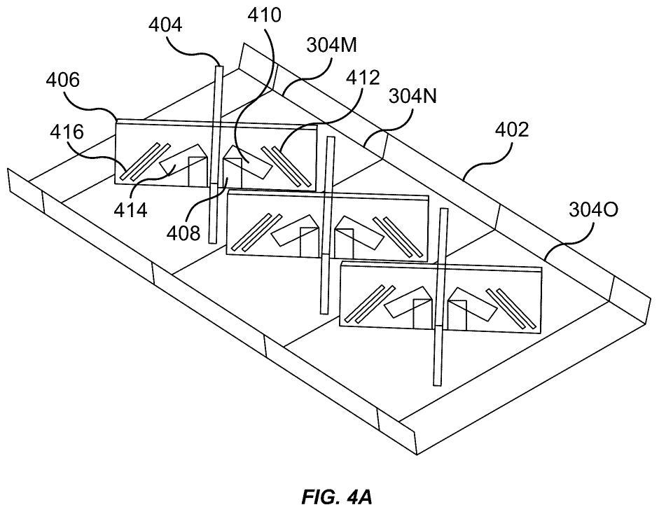

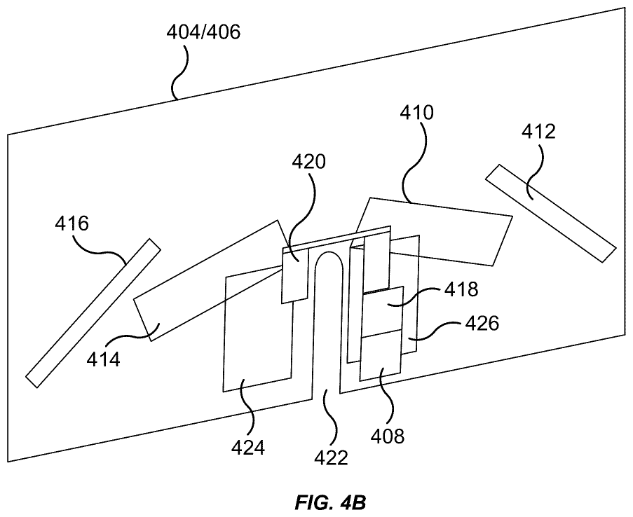

FIGS. 4A and 4B illustrate example components of an access point 102 in the system 100 of FIG. 1. Generally, FIGS. 4A and 4B show the structure of the antenna elements 304 in the access point 102. These antenna elements 304 include antenna components (e.g., radiators, reflectors, scatterers, etc.) positioned on intersecting substrates. Feeds communicate electrical signals to the antenna components, and vice versa. The feeds include portions that capacitively couple to each other across an intersecting substrate.

FIG. 4A shows the design of the antenna elements 304. The example of FIG. 4A includes the antenna elements 304M, 304N, and 304O. Each of the antenna elements 304M, 304N, and 304O includes similar or analogous components. For clarity, only the components of the antenna element 304M are labeled.

As seen in FIG. 4A, the antenna element 304M includes substrates 404 and 406. The substrates 404 and 406 may provide structural support for other components of the antenna element 304M. For example, the substrates 404 and 406 may be printed circuit boards onto which other components of the antenna element 304M couple. The substrates 404 and 406 intersect with each other. For example, the substrates 404 and 406 may be positioned orthogonal to each other and/or the substrates 404 and 406 may bisect each other. One or more of the substrates 404 and 406 may include a slot into which the other substrate 404 or 406 passes or interlocks. For example, the substrate 404 may include a slot and the substrate 406 may include a slot. A portion of the substrate 404 may be positioned in the slot in the substrate 406, and a portion of the substrate 406 may be positioned in the slot in the substrate 404. In this manner, the substrates 404 and 406 intersect and/or interlock with each other.

Components of the antenna element 304M are coupled to the substrates 404 and 406. The perspective of FIG. 4A shows the components on the substrate 406, but similar components may be arranged in a similar configuration on the substrate 404. As seen in FIG. 4A, a feed 408, a radiator 410, one or more reflectors/scatterers 412, a radiator 414, and one or more reflectors/scatterers 416 are coupled to the substrate 406. The feed 408 communicates electrical signals between the radiators 410 and 414 and other circuitry of the access point. Generally, the feed 408 includes two portions positioned on either side of the substrate 404. These portions may capacitively couple to each other across or through the substrate 404. One portion communicates electrical signals to and from the radiator 410, and the other portion communicates electrical signals to and from the radiator 414.

The radiators 410 and 414 couple to the feed 408. As seen in FIG. 4A, the radiators 410 and 414 are tilted. The radiators 410 and 414 convert electrical signals from the feed 408 into wireless signals that the radiators 410 and 414 then transmit. The radiators 410 and 414 may also receive wireless signals and convert those wireless signals into electrical signals that the radiators 410 and 414 then communicate to the feed 408. The reflectors/scatterers 412 and 416 are coupled to the substrate 406 and are positioned further away from the substrate 404 than the radiators 410 and 414. Generally, the reflectors redirect electromagnetic energy (e.g., wireless signals) towards the radiators 410 and 414. The scatterers redirect wireless signals transmitted by the radiators 410 and 414. For example, the scatterers may extend the width of the beam pattern (e.g., main lobe) produced by the radiators 410 and 414. Any number of reflectors/scatterers 412 and 416 may be coupled to the substrate 406 to direct wireless signals towards the radiators 410 and 414.

As discussed above, radiators and reflectors/scatterers may be similarly coupled to the substrate 404. Another feed may couple to the substrate 404 and communicate electrical signals to and from the radiators on the substrate 404. This other feed may also include portions positioned on either side of the substrate 406. These portions capacitively couple to each other across and through the substrate 406. The antenna elements 304N and 304O may include similar configurations of substrates, feeds, radiators, and reflectors/scatterers.

FIG. 4B shows the arrangement of the feed 408, radiators 410 and 414, and reflectors/scatterers 412 and 416 on the substrate 404 or 406. As seen in FIG. 4B, the substrate 404 or 406 defines a slot 422 that extends from the bottom of the substrate 404 or 406 towards the top of the substrate 404 or 406 (which may be referred to as a bottom slot). In some instances, the slot 422 may instead extend from the top of the substrate 404 or 406 towards the bottom of the substrate 404 or 406 (which may be referred to as a top slot). A substrate 404 or 406 with a bottom slot may interlock with a substrate 404 or 406 with a top slot by engaging the top slot with the bottom slot. In this manner, the substrates 404 and/or 406 intersect with each other.

The feed 408 includes a portion 418 and a portion 420. The portions 418 and 420 may be positioned on different sides of the slot 422. As a result, the portions 418 and 420 may be separated from each other by an intersecting substrate. The portions 418 and 420 may capacitively couple to each other across and through the intersecting substrate. The portion 418 may receive an electrical signal for communication. The portion 418 may communicate the electrical signal to the radiator 410. Additionally, the portion 418 may communicate the electrical signal to the portion 420 across the capacitive coupling. The portion 420 then communicates the electrical signal to the radiator 414. The radiators 410 and 414 convert the electrical signal into a wireless signal and transmit the wireless signal. The radiators 410 and 414 may also receive a wireless signal and convert the wireless signal into an electrical signal. The radiator 410 communicates the electrical signal to the portion 418. The radiator 414 communicates the electrical signal to the portion 420. The portion 420 communicates the electrical signal to the portion 418 across the capacitive coupling.

Additionally, as seen in FIG. 4B, the radiator 414 is supported by a support 424, and the radiator 410 is supported by a support 426. The supports 424 and 426 may provide structural and/or mechanical support to tilt the radiators 410 and 414. In this manner, the supports 424 and 426 allow the radiators 410 and 414 to transmit a more consistent electrical signal and/or beam pattern over time.

As discussed previously, the design of the antenna elements may reduce the sidelobes on the beam pattern produced by the radiators. The reduced sidelobes reduce interference with other, neighboring antenna arrays. As a result, it is possible for the antenna arrays to reuse frequencies. Additionally, the reflectors/scatterers may extend the width of the main lobe of the beam pattern produced by the radiators, which improves wireless communication with connected devices.

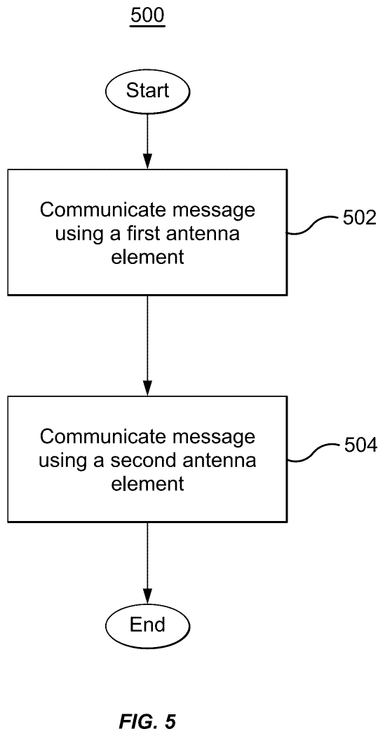

FIG. 5 is a flowchart of an example method 500 performed by the system 100 of FIG. 1. In certain embodiments, an access point (e.g., the access point 102 shown in FIG. 1) performs the method 500. By performing the method 500, the access point communicates messages using an antenna array with cross-polarized antenna elements.

In block 502, the access point communicates a message using a first antenna element. The first antenna element may include substrates that cross over or intersect with each other (e.g., intersect orthogonally with each other). Each substrate may have radiators and/or reflectors/scatterers positioned on the substrate on either side of the intersecting substrate. A first feed may communicate electrical signals to the radiators on a substrate. The first feed has a first portion on one side of the intersecting substrate that feeds the radiator on that side of the intersecting substrate. The first feed also has a second portion on the other side of the intersecting substrate that feeds the radiator on that side of the intersecting substrate. The first and second portions capacitively couple to each other across or through the intersecting substrate.

The access point may include other antenna elements. In block 504. the access point communicates a message using a second antenna element. If the second antenna element is part of the same radio as the first antenna element, then the message communicated by the second antenna element may be the same as the message communicated by the first antenna element. Like the first antenna element, the second antenna element may include substrates that cross over or intersect with each other (e.g., intersect orthogonally with each other). Each substrate may have radiators and/or reflectors/scatterers positioned on the substrate on either side of the intersecting substrate. A third feed may communicate electrical signals to the radiators on a substrate. The third feed has a first portion on one side of the intersecting substrate that feeds the radiator on that side of the intersecting substrate. The third feed also has a second portion on the other side of the intersecting substrate that feeds the radiator on that side of the intersecting substrate. The first and second portions capacitively couple to each other across or through the intersecting substrate.

In summary, the present disclosure describes a directional antenna array 108. The antenna array 108 includes a first antenna element 304A and a second antenna element 304B. The first antenna element 304A includes a first substrate 404, a second substrate 406 extending through the first substrate 404, a first feed 408 coupled to the first substrate 404, a first radiator 410 coupled to the first substrate 404 and electrically coupled to the first feed 408, a second feed coupled to the second substrate 406, and a second radiator coupled to the second substrate 406 and electrically coupled to the second feed. The first feed 408 includes a first portion 418 and a second portion 420 capacitively coupled to the first portion 418 through the second substrate 406. The second feed includes a third portion and a fourth portion capacitively coupled to the third portion through the first substrate 404.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An antenna array comprising:
a first antenna element comprising:
a first substrate;
a second substrate extending through the first substrate and orthogonal to the first substrate;
a first feed coupled to the first substrate, wherein the first feed comprises a first portion and a second portion capacitively coupled to the first portion through the second substrate;
a first radiator coupled to the first substrate and electrically coupled to the first feed;
a second feed coupled to the second substrate, wherein the second feed comprises a third portion and a fourth portion capacitively coupled to the third portion through the first substrate; and
a second radiator coupled to the second substrate and electrically coupled to the second feed; and
a second antenna element.

2. The antenna array of claim 1, wherein the first antenna element further comprises a third radiator coupled to the first substrate and electrically coupled to the first feed, wherein the first radiator and the third radiator are positioned on opposite sides of the second substrate.

3. The antenna array of claim 1, wherein the first antenna element further comprises a scatterer coupled to the first substrate and arranged to scatter a wireless signal transmitted by the first radiator.

4. The antenna array of claim 1, wherein the first substrate defines a slot and wherein the second substrate is positioned in the slot.

5. The antenna array of claim 1, wherein the second antenna element comprises:
a third substrate;
a fourth substrate extending through the third substrate and orthogonal to the third substrate;
a third feed coupled to the third substrate, wherein the third feed comprises a fifth portion and a sixth portion capacitively coupled to the fifth portion through the fourth substrate;
a third radiator coupled to the third substrate and electrically coupled to the third feed;
a fourth feed coupled to the fourth substrate, wherein the fourth feed comprises a seventh portion and an eighth portion capacitively coupled to the seventh portion through the third substrate; and
a fourth radiator coupled to the fourth substrate and electrically coupled to the fourth feed.

6. The antenna array of claim 1, wherein the first radiator converts an electrical signal from the first feed into a wireless signal.

7. The antenna array of claim 1, further comprising a third antenna element.

8. The antenna array of claim 1, wherein the first substrate bisects the second substrate.

9. A method comprising:
communicating a message using a first antenna element comprising:
a first substrate;
a second substrate extending through the first substrate and orthogonal to the first substrate;
a first feed coupled to the first substrate, wherein the first feed comprises a first portion and a second portion capacitively coupled to the first portion through the second substrate;
a first radiator coupled to the first substrate and electrically coupled to the first feed;
a second feed coupled to the second substrate, wherein the second feed comprises a third portion and a fourth portion capacitively coupled to the third portion through the first substrate; and
a second radiator coupled to the second substrate and electrically coupled to the second feed; and
communicating a message using a second antenna element.

10. The method of claim 9, wherein the first antenna element further comprises a third radiator coupled to the first substrate and electrically coupled to the first feed, wherein the first radiator and the third radiator are positioned on opposite sides of the second substrate.

11. The method of claim 9, wherein the first antenna element further comprises a scatterer coupled to the first substrate and arranged to scatter a wireless signal transmitted by the first radiator.

12. The method of claim 9, wherein the first substrate defines a slot and wherein the second substrate is positioned in the slot.

13. The method of claim 9, wherein the second antenna element comprises:
a third substrate;
a fourth substrate extending through the third substrate and orthogonal to the third substrate;
a third feed coupled to the third substrate, wherein the third feed comprises a fifth portion and a sixth portion capacitively coupled to the fifth portion through the fourth substrate;
a third radiator coupled to the third substrate and electrically coupled to the third feed;
a fourth feed coupled to the fourth substrate, wherein the fourth feed comprises a seventh portion and an eighth portion capacitively coupled to the seventh portion through the third substrate; and
a fourth radiator coupled to the fourth substrate and electrically coupled to the fourth feed.

14. The method of claim 9, wherein the first radiator converts an electrical signal from the first feed into a wireless signal.

15. The method of claim 9, further comprising communicating a message using a third antenna element.

16. The method of claim 9, wherein the first substrate bisects the second substrate.

17. An access point comprising:
a first substrate;
a second substrate extending through the first substrate and orthogonal to the first substrate;
a first feed coupled to the first substrate, wherein the first feed comprises a first portion and a second portion capacitively coupled to the first portion through the second substrate; and
a second feed coupled to the second substrate, wherein the second feed comprises a third portion and a fourth portion capacitively coupled to the third portion through the first substrate.

18. The access point of claim 17, wherein the first substrate defines a slot and wherein the second substrate is positioned in the slot.

19. The access point of claim 17, wherein the first substrate bisects the second substrate.

20. The access point of claim 17, further comprising a radiator coupled to the first substrate and electrically coupled to the first feed.
